(19) United States
(12) Patent Application Publication
(10) Pub. No.: US 2022/0108182 A1
(43) Pub. Date: Apr. 7, 2022

(54) METHODS AND APPARATUS TO TRAIN MODELS FOR PROGRAM SYNTHESIS

(71) Applicant: Intel Corporation, Santa Clara, CA (US)

(72) Inventors: Todd A. Anderson, Hillsboro, OR (US); Shengtian Zhou, Palo Alto, CA (US); Javier Turek, Beaverton, OR (US); Celine Lee, Sunnyvale, CA (US); Justin Gottschlich, Santa Clara, CA (US)

(21) Appl. No.: 17/551,170

(22) Filed: Dec. 14, 2021

(51) Int. Cl. G06N 3/08; G06F 40/30; G06N 3/04

(52) U.S. Cl. CPC G06N 3/086; G06N 3/04; G06F 40/30

(57) ABSTRACT

Methods and apparatus to train models for program synthesis are disclosed. A disclosed example apparatus includes at least one memory, instructions, and processor circuitry. The processor circuitry is to execute the instructions to sample pairs of programs, the pairs of programs including first programs and second programs, the first programs including natural language descriptions and second programs, calculate program similarity scores corresponding to the pairs of programs, and train a model based on entries corresponding to ones of the pairs of programs, at least one of the entries including a corresponding one of the natural language descriptions with a paired one of the second programs, and a corresponding one of the program similarity scores.

### FIELD OF THE DISCLOSURE

This disclosure relates generally to machine programming and, more particularly, to methods and apparatus to train models for program synthesis.

### BACKGROUND

Machine programming (MP) is related to the automation of software development. For example, program synthesis is an MP technique that has gained traction in recent years. Particularly, genetic algorithms (GAs) have been increasingly implemented as a program synthesis technique to enable automated software construction. For program synthesis systems, a specification for program behavior is typically provided to a system so that a program with the specified behavior can be constructed and/or generated. Many known program synthesis systems rely on sets of input/output examples for the programmer to specify the behavior of the program that they wish the program synthesis system to create. According to some known programming synthesis systems, each element of an input/output set contains a possible input to a program, as well as a corresponding desired output that is generated by transforming the input by a synthesized program. However, efforts to synthesize the program by these techniques can be tedious and time-consuming.

### BRIEF DESCRIPTION OF THE DRAWINGS

FIG. 1 is an overview of an example program synthesis system in accordance with teachings of this disclosure.

FIG. 2 is a block diagram of an example model analysis system in accordance with teachings of this disclosure.

FIG. 3 is an overview of an example neural network that can be implemented based on examples disclosed herein.

FIG. 4 is an overview of another example neural network that can be implemented based on examples disclosed herein.

FIGS. 5 and 6 are flowcharts representative of example machine readable instructions and/or example operations that may be executed by example processor circuitry to implement the example program synthesis system of FIG. 1 and/or the example model analysis system of FIG. 2.

FIG. 7 is a block diagram of an example processing platform including processor circuitry structured to execute the example machine readable instructions and/or the example operations of FIGS. 5 and/or 6 to implement the example program synthesis system of FIG. 1 and/or the example model analysis system of FIG. 2.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 5 and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Methods and apparatus to train models for program synthesis are disclosed. Machine programming (MP) is related to the automation of software development. For example, genetic algorithms (GAs) have been increasingly implemented as a program synthesis technique to enable automated software construction. Many known program synthesis systems rely on sets of input/output examples. However, utilizing input/output sets for program synthesis can be tedious and time consuming.

Examples disclosed herein utilize machine learning (ML) that utilizes programs in combination with natural language descriptions of program behavior and/or specifications to accurate synthesize programs in a relatively quick and time-efficient manner. In particular, some examples disclosed herein can increase a speed at which GA-based program synthesis tools are able to synthesize programs. Further, examples disclosed herein can increase a number and/or a size of programs that a system is able to access for different functions and/or specifications (e.g., program specifications). Even further, examples disclosed herein can also decrease and/or eliminate a number of input/output examples necessitated for program synthesis.

In a model training phase, examples disclosed herein sample at least one pair of programs which, in turn, include a first program having a corresponding natural language descriptions, as well as a second program, which may be randomly generated, produced in a GA and/or retrieved/accessed (e.g., an existing program that is retrieved). In turn, according to examples disclosed herein, program similarity scores are calculated for the aforementioned pair(s) of programs. Accordingly, a model is trained based on entries corresponding to the respective pairs. Ones of the entries include a natural language description (associated with one of the first programs) with a corresponding paired one of the second programs, as well as a respective program similarity score that functions as a label for the model. As a result, the model can be utilized in an inference phase to facilitate and/or enable efficient synthesis of programs, which may be accessed or generated (e.g., randomly generated, generated in a GA, etc.). Additionally or alternatively, the trained model can be utilized to adjust parameters and/or aspects of a GA. In some examples, the trained model is used to select programs with a relatively high program similarity score for use in a GA.

In some examples, ones of the pairs are filtered. For some such examples, ones of the pairs with similarity scores that are within a threshold similarity of other pairs can be deleted and/or removed from further analysis to enable a more even distribution of pairs with differing similarity scores. In some examples, the trained model is implemented (after being trained) to provide a fitness score and/or similarity score of a program (e.g., a candidate program) associated with a GA program and/or process in conjunction with a natural language description (e.g., a natural language text specification for a program). Additionally or alternatively, the trained model is utilized to adjust, refine and/or further train the GA program and/or process. The trained model can be utilized to provide programs to a GA with similarity scores to corresponding natural language text that exceeds a threshold similarity score value. In some examples, the similarity scores are calculated utilizing a code semantics similarity, such as a machine-inferred code similarity (MISIM) system or Aroma code recommendation software.

In some examples, the second programs are programs generated via a GA. In some such examples, the programs are iteratively combined and modified (e.g., cross-bred, selectively cross-bred, mutated, etc.). Accordingly, the programs can be evaluated with a score (e.g., a fitness score, a similarity score, etc.) to characterize whether the programs are improving (e.g., evolving), an effectiveness of the GA and/or an associated GA process. In some such examples, the GA and/or parameters of the GA can be adjusted based on utilizing the trained model. In particular, the GA can be adjusted based on fitness and/or similarity scores of programs evaluated by the trained model. Additionally or alternatively, programs that are provided to the GA may be based on fitness scores determined by the trained model. In particular, the GA can preferentially copy, crossbreed, or mutate higher scoring programs to be represented in the next generation programs with higher similarity scores, for example.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a long-short-term memory (LSTM) model is used. Using an LSTM model enables encoding of programs and natural language text for a fitness and/or similarity evaluation of a program, for example. In general, machine learning models/architectures that are suitable to use in the example approaches disclosed herein will be a recurrent neural network (RNN), a transformer machine learning model, a gated recurrent unit (GRU), or temporal convolutional network (TCN). However, other types of machine learning models could additionally or alternatively be used such as a temporal convolutional network, etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using LSTM neural networks. However, any other training algorithm may additionally or alternatively be used. In examples disclosed herein, training is performed until a trained model can output a fitness and/or similarity score of a program relative to natural language text with a relative degree of accuracy. In some examples disclosed herein, training is performed until a requisite/sufficient number of programs (e.g., all the programs for training/learning) have been utilized in training the model. Training is performed using hyperparameters that control how the learning is performed (e.g., a learning rate, a number of layers to be used in the machine learning model, etc.). In examples disclosed herein, hyperparameters that control aspects of fitness determination of programs are utilized. In some examples, re-training may be performed. Such re-training may be performed in response to an amount of data that can be utilized to train the model and/or the trained model to reach a requisite degree of accuracy in determining fitness and/or similarity scores, for example.

Training is performed using training data. In examples disclosed herein, the training data originates from natural language descriptions and/or programs. Because supervised training is used, the training data is labeled. According to examples disclosed herein, labeling is applied to the training data as a program similarity score.

Once training is complete, the model is deployed for use as an executable construct that processes an input and provides an output based on the network of nodes and connections defined in the model. The model is stored at a data storage device or data store.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

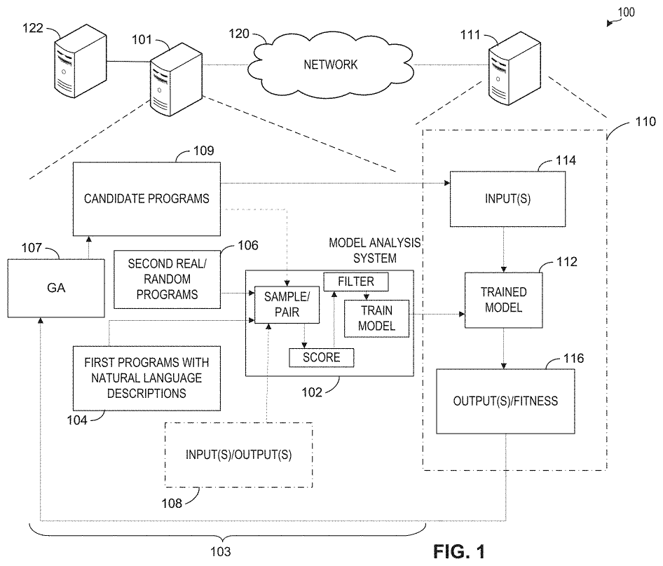

FIG. 1 is an overview of an example program synthesis system 100 in accordance with teachings of this disclosure. The example program synthesis system 100 of the illustrated example includes a computing device 101 to perform an inference phase 103 with a model analysis system 102. In this example, the model analysis system 102 is provided with first programs 104, which include programs with corresponding natural language descriptions (e.g., natural language descriptions of program specifications). Further, the example model analysis system 102 is also provided with second programs 106, which include programs that can be retrieved, accessed and/or generated (e.g., randomly generated). For example, the second programs can be generated through a GA process and/or system 107. However, the second programs 106 can be generated and/or obtained (e.g., retrieved) through any appropriate process, system and/or methodology. In some examples, input(s)/output(s) 108 are provided to the example model analysis system 102. In some examples, candidate programs 109 are generated by the GA process and/or system 107 and, in turn, provided to the model analysis system 102.

According to the illustrated example, an example computing device 111 is implemented to for an inference phase 110 corresponding to a trained model 112 that is provided from the example model analysis system 102. The trained model 112 of the illustrated example utilizes inputs 114, which may include at least one of the candidate programs 109 in combination with a corresponding natural language description, to provide output 116, which is a similarity or fitness score in this example. Additionally or alternatively, the computing device 101 is also utilized for the aforementioned inference phase 110. As can be seen in the illustrated example of FIG. 1, at least one of the computing device 101 and/or the computing device 111 is communicatively coupled to a network 120 and/or remote computing device(s) 122. However, any other appropriate computing implementation and/or network topology can be implemented instead.

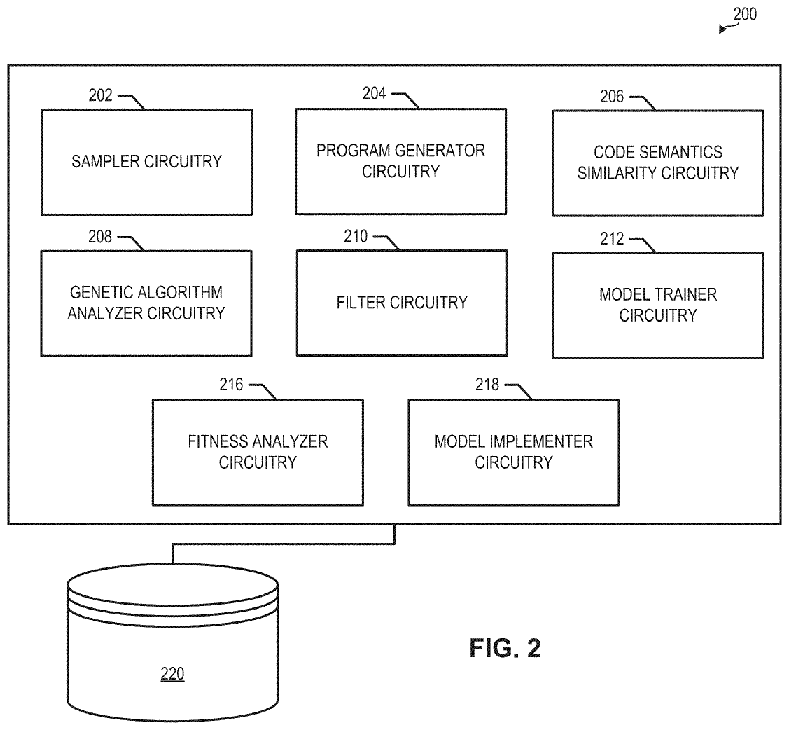

In operation, and as will be discussed in greater detail below in connection with FIGS. 2-9, examples disclosed herein can be implemented to improve generation and/or analysis of programs utilized in program synthesis, as well reduce time to generate and/or develop programs. In particular, examples disclosed herein utilize ML techniques to train models that aid in program synthesis.

To train the example model 112, the model analysis system 102 samples the first programs 104 and the second programs 106 to define pairs of ones of the first programs 104 and ones of the second programs 106. In particular, similarity scores of the aforementioned pairs are calculated. In this example, a code semantics similarity score of ones of the pairs is calculated using the aforementioned MISIM or Aroma scores, for example. Accordingly, entries are utilized to train the model 112. In this example, the entries include a natural language description of a paired one of the first programs 104 with a corresponding paired one of the second programs 106, as well as corresponding similarity score of the pair, which functions as a label for training the model 112. The example second programs 106 can, in turn, include programs, which can be retrieved (e.g., from a server and/or library, randomly generated and/or generated in a GA, such as the GA process and/or system 107 of FIG. 1. Additionally or alternatively, the example model analyzer 102 is provided with the input(s)/output(s) 108 for training, development and/or generation of the model (e.g., in combination with the pairs and natural language description). In some such examples, the entries include a natural language description of a paired one of the first programs 104 with a corresponding paired one of the second programs 106, as well as corresponding similarity score of the pair with respective one(s) of the input(s)/output(s) 108. In some examples, at least one of the pairs is filtered prior to being forwarded for training of the model 112. In some such examples, pairs with predominant scores are reduced and/or eliminated, thereby enabling a relatively even distribution of scores for the pairs.

Once the model 112 is trained, the input(s) 114 can include natural language text with a corresponding program. In turn, the model 112 can provide and/or generate the output(s) 116, which includes a similarity or fitness score. In this example, the score corresponds to a degree of relevance of the program provided as input with the corresponding natural text. In some examples, programs with scores calculated from the trained model 112 that are above a threshold are used in conjunction with the GA process and/or system 107 for further iterations and/or cross-breeding between programs to yield programs with relatively higher fitness scores. In other words, the model 112 can be trained to evaluate a synthesis process for a program and/or facilitate generation of a program that more closely matches specifications associated with the natural language text.

The computing and/or network communication implementation shown in FIG. 1 is only an example and any appropriate computing device implementation and/or network topology can be utilized instead. For example, the training and implementation phases of the model 112 can be performed by the computing device 101.

FIG. 2 is a block diagram of an example model analysis system 200 in accordance with teachings of this disclosure. The example model analysis system 200 of FIG. 2 can implement the model analysis system 102 of FIG. 1 and may be instantiated (e.g., creating an instance of, bring into being for any length of time, materialize, implement, etc.) by processor circuitry such as a central processing unit executing instructions. Additionally or alternatively, the model analysis system 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

The example model analysis system 200 includes example sampler circuitry 202, example program generator circuitry 204, example code semantics similarity circuitry 206, example GA analyzer circuitry 208, example filter circuitry 210, example model trainer circuitry 212, example fitness analyzer circuitry 216, and example model implementer circuitry 218. In this example, the model analysis system 200 is communicatively coupled to a data storage 220.

The sampler circuitry 202 of the illustrated example samples one of the first programs 104 with natural language descriptions (e.g., as metadata or an external attachment) and ones of the second programs 106 to define pairs therebetween. In particular, ones of the pairs includes one of the first programs 104 with a corresponding natural language description and/or text, and one of the second programs 106. In this example, the sampler circuitry 202 randomly pairs ones of the first programs 104 with ones of the second programs 106 to define the pairs. In some examples, the first programs 104 and/or the second programs 106 can number in the thousands or millions. However, any appropriate number of the first programs 104 and/or the second programs 106 can be implemented instead. In some other examples, the pairs are defined based on a degree of similarity between a first one of the first programs 104 and a second one of the second programs 106. Additionally or alternatively, the sampler circuitry 202 samples and/or takes into account the input(s)/output(s) 108, which can include pairs of inputs and outputs corresponding to known and/or released programs. Additionally or alternatively, the input(s)/output(s) 108 are paired with corresponding ones of the first programs 104 and/or ones of the second programs 106. In some examples, the first programs 104, the second programs 106 and/or the input(s)/output(s) 108 of FIG. 1 are stored in the storage 220.

In an example, ones of a set of sample programs, S, and the equivalent natural language description of those programs and optionally other specifications such as input/output examples can be combined by the sample circuitry 202 with ones of randomly generated programs, R, which do not have associated natural language descriptions. Accordingly, the sampler circuitry 202 can generate a significant number of pairs of programs (e.g., thousands to millions of pairs of programs, etc.), where a first program in a pair comes from S and a second program in a pair may come from either S or R.

The example program generator circuitry 204 generates (e.g., randomly generates) and/or refines (e.g., via multiple iterations) programs (e.g., candidate programs), which may encompass the second programs 106, for example. According to some examples, the candidate programs can be randomly generated and/or obtained from sources external to the model analysis system 200 (e.g., via the network 120 shown in FIG. 1). In some examples, the program generator circuitry 204 generates the candidate programs via a GA, such as the example GA process and/or system 107 shown in FIG. 1. In some examples, the program generator circuitry 204 retrieves existing stored programs (e.g., from the storage 220).

In this example, the code semantics similarity circuitry 206, determines similarities of the aforementioned pairs created by the example sampler circuitry 202. In particular, the example code semantics similarity circuitry 206 determines a degree of similarity (e.g., a similarity score or index) between ones (e.g., all) of the pairs generated by the example sampler circuitry 202. In some examples, the code semantics similarity circuitry 206 calculates and/or implements determination of the aforementioned MISIM or Aroma based program correctness scores to determine the degree of similarity. Additionally or alternatively, the pairs are ranked and/or sorted based on the aforementioned degree of similarity.

In some examples, the GA analyzer circuitry 208 is implemented to evaluate and/or adjust candidate programs generated by the program generator circuitry 204 and/or the GA system and/or process 107 shown in FIG. 1. In some examples, the GA analyzer circuitry 208 determines whether the GA utilized by the program generator circuitry 204 is successfully “evolving” candidate programs. As used herein, “evolving” refers to cross-breeding and/or mutating candidate programs such that more “fit” candidate programs are selected for continuing in the process. In turn, the GA analyzer circuitry 208 can direct an adjustment and/or modification of the GA and/or parameters associated with the GA.

In the illustrated example of FIG. 2, the filter circuitry 210 is utilized to filter the aforementioned pairs generated and/or defined by the sampler circuitry 202. According to some examples disclosed herein, pairs are filtered based on a degree of similarity and/or a similarity score. For example, ones of the pairs with the degree of similarity less than a threshold value are filtered and/or removed. Additionally or alternatively, the filter circuitry 210 performs filtering to randomly eliminate a requisite number or an amount of examples of each of the more predominant correctness and/or similarity scores until all correctness scores are relatively equivalently represented. In some examples, the filter circuitry 210 performs filtering to create a relatively equal distribution of training examples across all similarity classification score classes of programs. In other words, the filter circuitry 210 can control a distribution of the programs. However, in some examples, it may not be possible to completely equalize the distribution of training examples. In some examples, the filter circuitry 210 performs filtering to weigh categories and/or classifications to compensate for a difference in a number of training examples.

The model trainer circuitry 212 of the illustrated example trains, generates and/or develops a model based on entries corresponding to the pairs filtered in some examples by the filter circuitry 210. In this example, the model trainer circuitry utilizes an LSTM network (e.g., a sequential network, a bi-directional LSTM network, etc.) to train a network with the filtered pairs including ones of the first programs 104 and ones of the second programs 106. However, any appropriate type of neural network architecture can be implemented instead.

In this example, the model may be trained by the model trainer circuitry 212 with data to recognize patterns and/or associations and follow such patterns and/or associations when processing input data such that other input(s) result in output(s) consistent with the recognized patterns and/or associations. Many different types of machine learning models and/or machine learning architectures exist. In examples disclosed herein, an LSTM model is used. Using an LSTM model enables encoding of text for a fitness evaluation of a program, for example. In general, machine learning models/architectures that are suitable to use in the example approaches disclosed herein will be an RNN, a transformer machine learning model, GRU, or TCN. However, other types of machine learning models could additionally or alternatively be used such as a temporal convolutional network, etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using LSTM neural networks. However, any other training algorithm may additionally or alternatively be used. In examples disclosed herein, training is performed until a trained model can output a fitness score with a relative degree of accuracy and/or a sufficient number of programs are utilized to perform the training. Training is performed using hyperparameters that control how the learning is performed (e.g., a learning rate, a number of layers to be used in the machine learning model, etc.). In examples disclosed herein, hyperparameters that control aspects of fitness determination of programs. In some examples re-training may be performed. Such re-training may be performed in response to an amount of data that can be utilized to train the model and/or the trained model reaching a requisite degree of accuracy in determining fitness scores, for example.

Training is performed using training data. In examples disclosed herein, the training data originates from natural language descriptions and programs. Because supervised training is used, the training data is labeled. Labeling is applied to the training data as a program similarity score.

Once training is complete, the model is deployed for use as an executable construct that processes an input and provides an output based on the network of nodes and connections defined in the model. The model is stored at a data storage and/or a computing device that is utilized for training and/or implementation of the model, for example.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

The example fitness analyzer circuitry 216 can be utilized to analyze and/or determine a fitness of at least one program (e.g., from the second programs 106) from a GA, or from a repository of stored programs. Additionally or alternatively, the fitness analyzer circuitry 216 can analyze a program that is randomly generated. In particular, the example fitness analyzer circuitry 216 can be implemented to adjust a manner and/or a degree to which candidate programs are developed and/or iterated in a GA. In other words, the fitness analyzer circuitry 216 can be used to adjust a GA and/or models being developed and/or selected as inputs to the GA. In some examples, the fitness analyzer circuitry 216 is implemented to determine which programs and/or candidate programs are to be mutated, iterated and/or cross-bred in the GA (e.g., based on fitness and/or similarity scores).

The example model implementer circuitry 218 can be utilized to implement the trained model trained by the example model trainer circuitry 212. For example, the model implementer circuitry 218 can provide inputs to the trained model to determine a fitness of a program (e.g., a candidate program). According to examples disclosed herein, the inputs to the trained model can include a natural language description and the program. Accordingly, the output from the trained model can be a fitness and/or similarity score of the program. In turn, as mentioned above, the fitness analyzer circuitry 216 can adjust aspects/parameters of the GA and/or candidate models being selected for further processing by the GA.

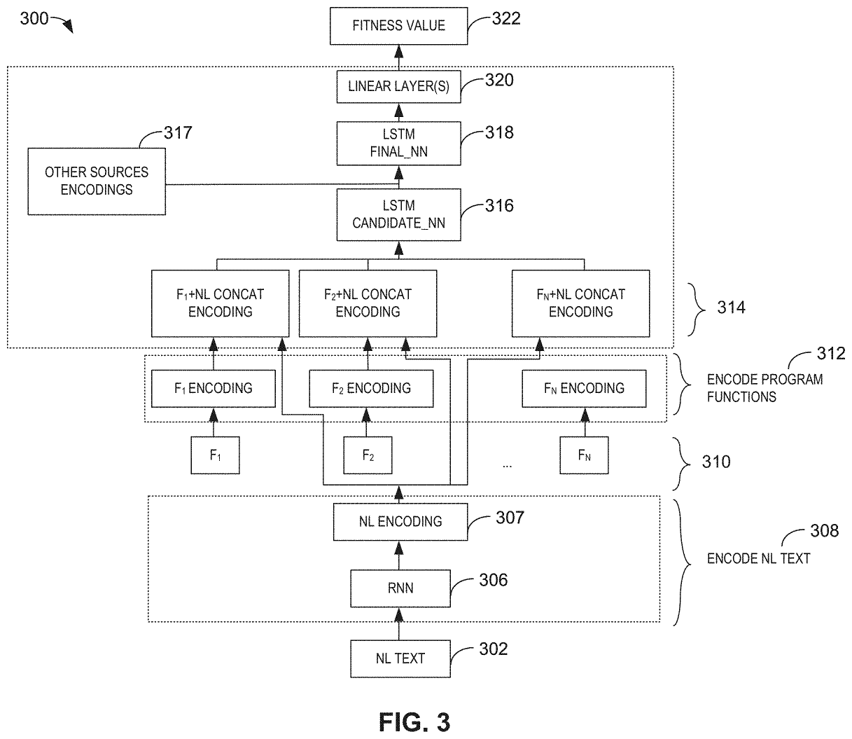

FIG. 3 is an overview of an example neural network 300 that can be implemented in examples disclosed herein. The example neural network 300 is implemented to evaluate and/or calculate a degree between input programs and corresponding natural language descriptions and/or text. The example neural network 300 is LSTM-based (e.g., based on a bi-directional LSTM architecture, based on a sequential LSTM architecture, etc.) in this example. However, any appropriate other network architecture, encoding and/or input processing methodology can be implemented instead. As input, the neural network 300 of the illustrated example receives and/or accesses natural language text along with a corresponding program (e.g., a candidate program, an input program) to produce an output value or score (e.g., a fitness score, a relevance score, a similarity score, etc.). In some examples, the natural language text along and the corresponding program are combined and/or concatenated.

In the illustrated example of FIG. 3, to execute the neural network in an implementation/inference phase, natural language text (e.g., a natural language text description) 302 is provided as an input to an RNN 306, and encoded to yield natural language encoding 307. Further, according to some examples disclosed herein, the aforementioned program is separated into and/or designated by functions 310. In particular, the example functions 310 are function calls of the program encoded to define encoded program functions 312. Further, in this example, the encoded program functions 312 associated with the aforementioned program and the natural language encoding 307 are concatenated to define concatenated encodings 314. In this example, the natural language encoding 308 is concatenated with ones of the encoded program functions 312 corresponding to a respective program. In the illustrated example, the combined encoding of natural language text and program functions corresponds to a vector that is generated for a neural network 316. In turn, the combined encodings and/or associated vectors are then provided to the neural network 316 (e.g., another LSTM), denoted as candidate_nn in FIG. 3, to generate a fitness score with respect to natural language description text and functions of the program. In examples where there are no other specifications, this fitness score can be a final score. Alternatively, if there are other specifications, then the output of candidate_nn can be provided to another system, such as another neural network 318, denoted as final_nn in FIG. 3 to generate a score (e.g., a final fitness score, a fitness value, a similarity score, a correctness score, etc.) 322. In some examples, encoding from other sources, such as input/output pairs and/or other information such as program specifications, are provided to the neural network 318. In this example, linear layer(s) 320 are used to generate the score 322 of the input program as output of the neural network 300. However, any appropriate network structure, encoding and/or layering can be implemented instead.

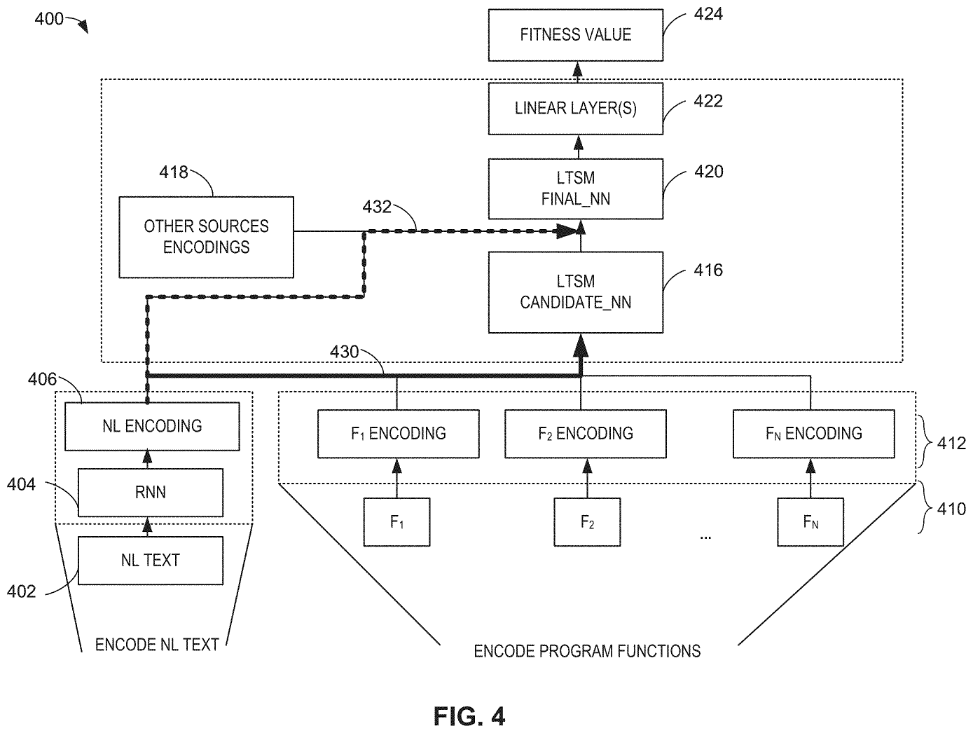

FIG. 4 is an overview of another example neural network 400 that can be implemented in examples disclosed herein. The example neural network 400 is similar to the example neural network 300 shown in FIG. 3 in that the neural network 400 is trained to evaluate a degree of similarity between a program (e.g., a candidate program) and natural language description text. In contrast to the example neural network 300, the example neural network 400 instead utilizes different encoding steps and an overall layering structure. Particularly, program functions are encoded separate from encoding of natural language text pertaining to a specification of a program, for example.

In the illustrated example of FIG. 4, natural language text 402 is provided to an RNN 404 and encoded, thereby defining natural language encoding 406. Further program functions 410 are encoded to define encoded functions 412. In this example, encoded functions 412 are provided to a neural network 416 (e.g., an LSTM), denoted as candidate_nn. Additionally or alternatively, the natural language encoding 406 is provided to the neural network 416. In this example, the neural network 416 provides its output to a neural network 420, denoted as final_nn, based on further specification (e.g., program requirements) of the input program. In some examples, other source encodings (e.g., input/output pairs, etc.) 418, such as input(s)/output(s) sets or examples, are provided to the aforementioned neural network 420 and/or the neural network 416. In particular, the other source encodings can be provided to the neural network 420 in scenarios with multiple product specifications, for example. In turn, an output of the neural network 420 is provided to linear layer(s) 422 to determine a fitness value 424, for example.

In some examples, the natural language encoding 406 is provided to the neural network 416, as generally shown by an arrow 430. Additionally or alternatively, the natural language encoding 406 is provided to the neural network 420 (e.g., for when additional specifications and/or requirements are to be evaluated), as generally shown by an arrow 432. However, any appropriate network structure and/or model layering can be implemented instead.

While an example manner of implementing the example model analysis system 200 of FIG. 2 is illustrated in FIG. 2, one or more of the elements, processes, and/or devices illustrated in FIG. 2 may be combined, divided, re-arranged, omitted, eliminated, and/or implemented in any other way. Further, the example sampler circuitry 202, the example program generator circuitry 204, the example code semantics similarity circuitry 206, the example GA analyzer circuitry 208, the example filter circuitry 210, the example model trainer circuitry 212, the example fitness analyzer circuitry 216, the example model implementer circuitry 218, and/or, more generally, the example model analysis system 200 of FIG. 2, may be implemented by hardware alone or by hardware in combination with software and/or firmware. Thus, for example, any of the example sampler circuitry 202, the example program generator circuitry 204, the example code semantics similarity circuitry 206, the example GA analyzer circuitry 208, the example filter circuitry 210, the example model trainer circuitry 212, the example fitness analyzer circuitry 216, the example model implementer circuitry 218, and/or, more generally, the example model analysis system 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model analysis system 200 of FIG. 2 may include one or more elements, processes, and/or devices in addition to, or instead of, those illustrated in FIG. 2, and/or may include more than one of any or all of the illustrated elements, processes and devices.

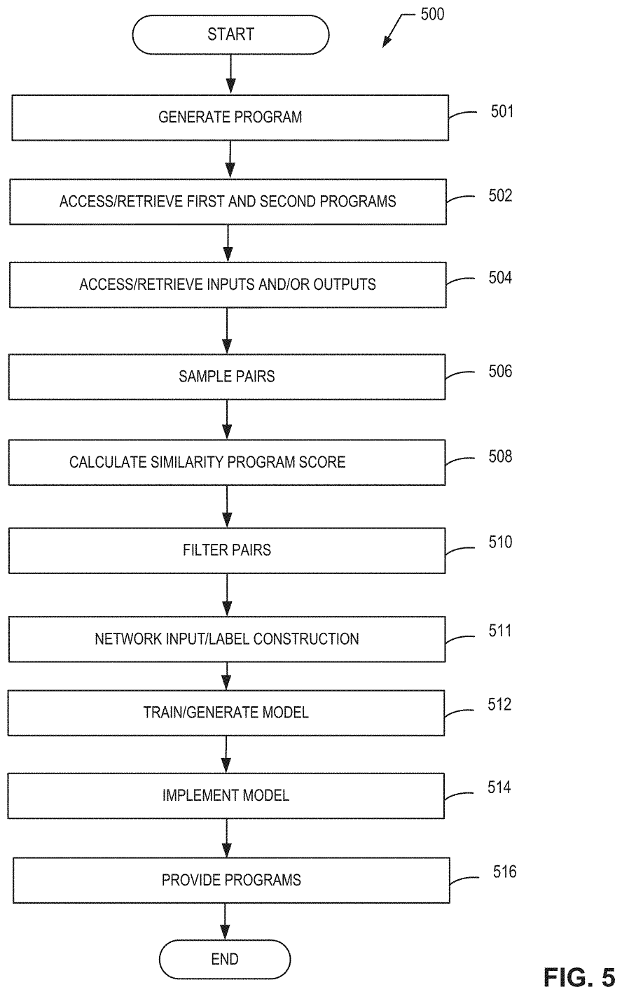

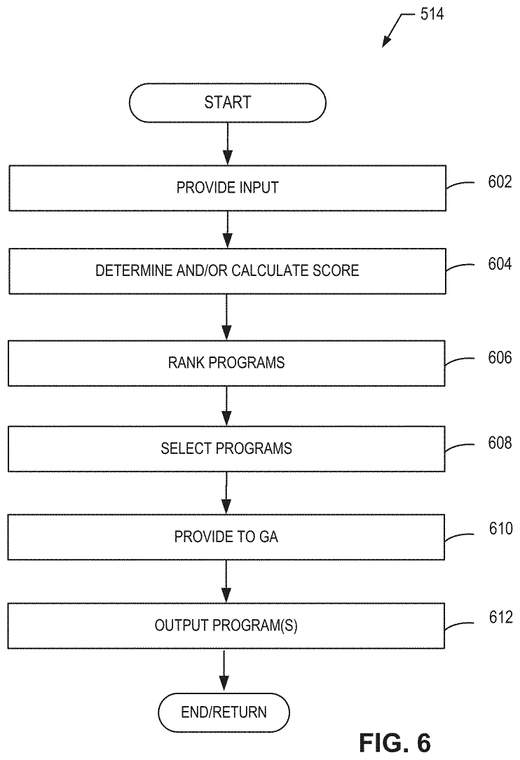

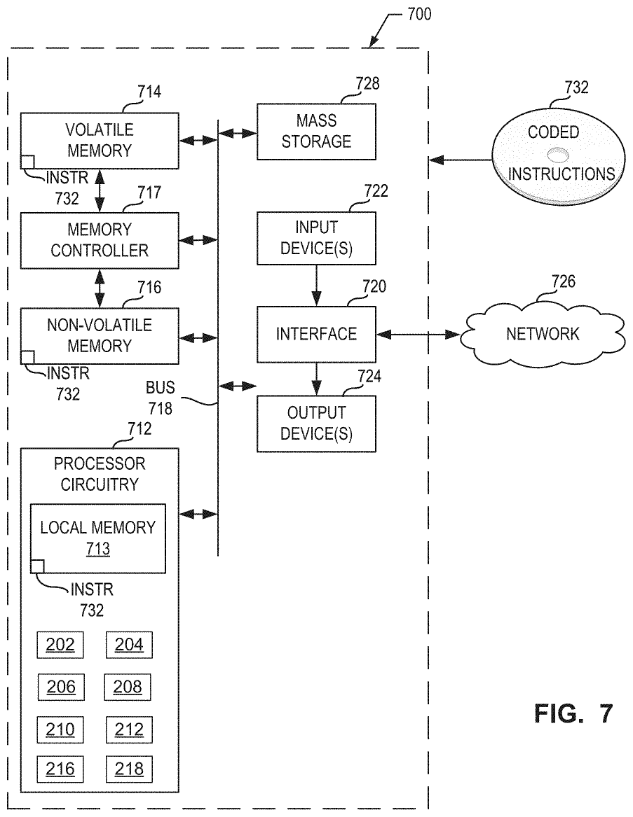

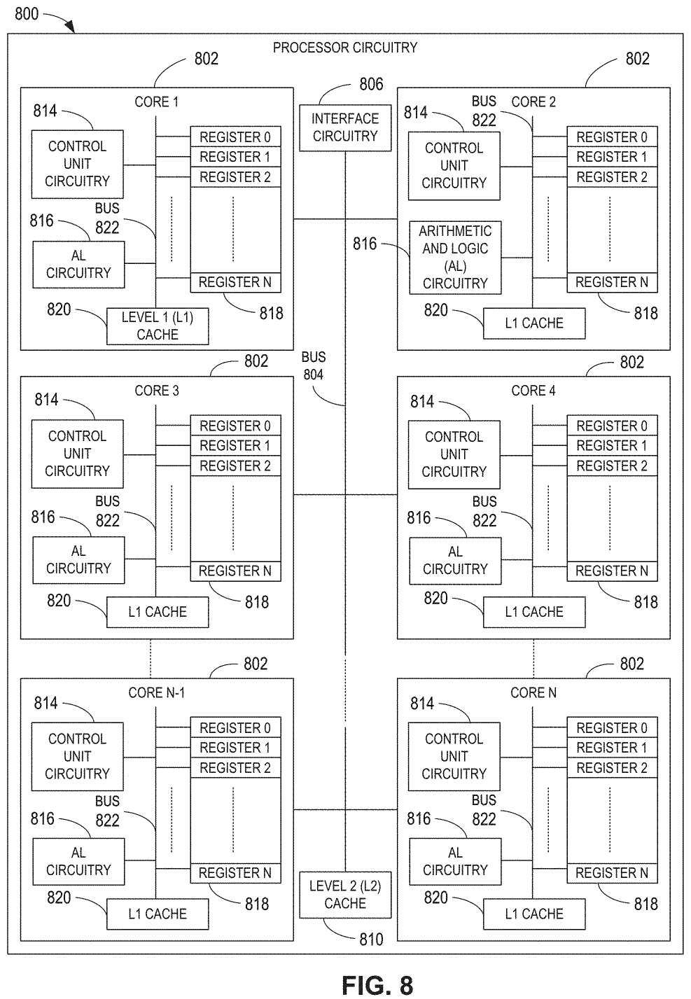

Flowcharts representative of example hardware logic circuitry, machine readable instructions, hardware implemented state machines, and/or any combination thereof for implementing the model analysis system 200 of FIG. 2 are shown in FIGS. 5 and 6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program(s) may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 5 and 6, many other methods of implementing the example model analysis system 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to implement the model analysis system 200 of FIG. 2 to train a model utilized for evaluation of programs in conjunction with natural language descriptions.

The machine readable instructions and/or operations 500 of FIG. 5 begin at block 501, at which a second program, such as one of the second programs 106 (FIG. 1), is generated (e.g., randomly generated, synthesized, etc.). In some examples, a GA generates the aforementioned second program.

At block 502, the example sampler circuitry 202 (FIG. 2) accesses and/or retrieves ones of first and second programs (e.g., first and second sets of programs, etc.), such as, the first programs 104 (FIG. 1) and the second programs 106, respectively. In this example, the first programs have associated natural language descriptions while the second programs are programs that are pre-existing or generated (e.g., in a GA and/or being processed in a GA) without corresponding natural language descriptions, for example.

At block 504, in some examples, input(s) and/or output(s) are accessed and/or received by the example sampler circuitry 202. For example, multiple sets of example inputs and corresponding outputs are accessed and/or received by the sampler circuitry 202.

At block 506, pairs of programs are sampled by the example sampler circuitry 202 of the illustrated example. In this example, the first and second programs are randomly paired. In some other examples, the first and second programs are paired by the sampler circuitry 202 based on an initial and/or predicted degree of similarity.

At block 508, in the illustrated example, the code semantics similarity circuitry 206 (FIG. 2) calculates a program similarity score for ones of the aforementioned pairs of programs. In this example, an MISIM system or Aroma system is utilized. In some examples, multiple scores are averaged (e.g., from different code semantics similarity systems and/or methodologies) for each of the pairs of programs.

At block 510, according to some examples disclosed herein, the example filter circuitry 210 (FIG. 2) filters pairs or programs. In some such examples, at least one of the pairs is randomly eliminated so that a requisite number of examples of predominant correctness scores are reduced until most or all similarity scores are more equivalently represented. In some examples, filtering results in a relatively equal distribution of training examples across all the classification classes but, in some examples, it may not be possible to completely equalize the training examples. Additionally or alternatively, in some examples, a filtering step is implemented to weight categories differently during training to compensate for differences in a number of training examples, for example.

At block 511, the example model trainer circuitry 212 (FIG. 2) generates network input/label constructions to train the model. In this example, a model input includes a natural language description and a corresponding paired one of the second programs. Further, the label for the model is the program similarity score calculated by the example code semantics similarity circuitry 206. In some examples, the model input includes an input and an output corresponding the input. In particular, the model input can be a natural language description, one of the second programs, and input(s) and/or output(s) (e.g., the input(s) being provided to the one of the second programs to provide the output(s)). Additionally or alternatively, the model input includes output from one of the first program based on input provided thereto. In such examples, the corresponding similarity score is a label.

At block 512, a model is trained (e.g., further trained, trained using supervised learning) and/or generated by the example model trainer circuitry 212. In this example, inputs to the aforementioned model include entries, each of which include the natural language description with the paired one of the second programs, along with the corresponding label including one of the program similarity scores. Additionally or alternatively, at least one of an input/output pair is included in ones of the entries. In some examples, the entry further includes a corresponding one of the first programs paired with the one of the second programs. Additionally or alternatively, the trained model is provided to the example model implementer circuitry 218 for an inference/implementation phase. In some examples, the model is trained through multiple networks (e.g., for multiple specifications), which may be in a sequential, bi-directional or non-sequential training process.

In the illustrated example, at block 514, the model implementation circuitry 218 (FIG. 2) implements the trained model, which is discussed in greater detail below in connection with FIG. 6. In this example. a natural language description and a program (e.g., a candidate program) are provided as inputs to the trained model. In turn, the trained model provides a similarity score and/or a fitness score. As a result, the trained model can determine a degree of similarity between the program and the natural language description as the aforementioned similarity score and/or a fitness score. In some examples, output of the trained model (e.g., a fitness score of a program provided as input) is provided to the example GA analyzer circuitry 208.

In some examples, at block 516, the example fitness analyzer circuitry 216 (FIG. 2) provides the program to a GA system and/or process. In some such examples, the fitness analyzer circuitry 216 provides the program to the GA system and/or process when the similarity score that is provided via the trained model exceeds a threshold value. In other words, the fitness analyzer circuitry 216 can determine which programs are to be further iterated and/or cross-bred in the GA system and/or process based on the similarity score while programs with lower similarity scores are not forwarded to the GA system and/or process. The example instructions and/or operations of FIG. 5 end.

FIG. 6 is a flowchart representative of an example subroutine 514 that may be used to implement block 514 of the example machine readable instructions and/or example operations 500 of FIG. 5. In this example, the subroutine 514 implements the trained model for evaluation, adjustment and/or input selection for a program synthesis system and/or implementation. However, in other examples, the trained model may be distributed and/or transmitted for use on other networks, computing devices and/or computational systems corresponding to a program synthesis system, for example.

At block 602, the example model implementer circuitry 218 (FIG. 2) provides inputs to the trained model. In the illustrated example, the inputs include natural language description text, as well as a program (e.g., a candidate program, a GA-generated program, a known existing program, etc.). Additionally or alternatively, input(s) and/or output(s) of programs are provided as inputs to the model, as mentioned above in connection with FIGS. 3 and 4, for example.

At block 604, the example model implementer circuitry 218 of the illustrated example determines and/or calculates a score (e.g., a similarity score, a correctness score, a fitness score, etc.) based on providing the aforementioned inputs to the trained model.

At block 606, in some examples, the model implementer circuitry 218 and/or the fitness analyzer circuitry 216 (FIG. 2) ranks programs based on their corresponding score.

At block 608, in some examples, the model implementer circuitry 218 and/or the fitness analyzer circuitry 216 select programs for which scores have been determined and/or calculated by the example model implementer circuitry 218. In some such examples, programs with scores below a threshold value can be eliminated and/or removed from consideration.

At block 610, in some examples, the fitness analyzer circuitry 216 and/or the GA analyzer circuitry 208 (FIG. 2) provides at least one program to a GA process and/or system, such as the GA 107 shown in FIG. 1. According to examples disclosed herein, the program(s) provided to the GA process and/or system can be programs with scores above a threshold. In turn, the programs forwarded to the GA process and/or system can be cross-bred, iteratively adjusted, evolved from, etc. Additionally or alternatively, the GA analyzer circuitry 208 adjust parameters and/or aspects of the GA process and/or system based on the scores determined and/or calculated by the example model implementer circuitry 218.

At block 612, in some examples, the model implementer circuitry 218 outputs programs deemed to match natural language description text to a requisite degree and the instructions and/or operations of FIG. 6 end.

FIG. 7 is a block diagram of an example processor platform 700 structured to execute and/or instantiate the machine readable instructions and/or operations of FIGS. 5 and 6 to implement the example model analysis system 200 of FIG. 2. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example sampler circuitry 202, the example program generator circuitry 204, the example code semantics similarity circuitry 206, the example GA analyzer circuitry 208, the example filter circuitry 210, the example model trainer circuitry 212, the example fitness analyzer circuitry 216, and the example model implementer circuitry 218.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 732, which may be implemented by the machine readable instructions of FIGS. 5 and 6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a general purpose microprocessor circuitry 800. The general purpose microprocessor circuitry 800 executes some or all of the machine readable instructions of the flowcharts of FIGS. 5 and 6 to effectively instantiate the circuitry of FIG. 2 as logic circuits to perform the operations corresponding to those machine readable instructions. In some such examples, the circuitry of FIG. 2 is instantiated by the hardware circuits of the microprocessor 800 in combination with the instructions. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by an example bus 804. In some examples, the bus_04 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor circuitry 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 5. Alternatively, the registers 818 may be organized in any other arrangement, format, or structure including distributed throughout the core 802 to shorten access time. The second bus 822 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

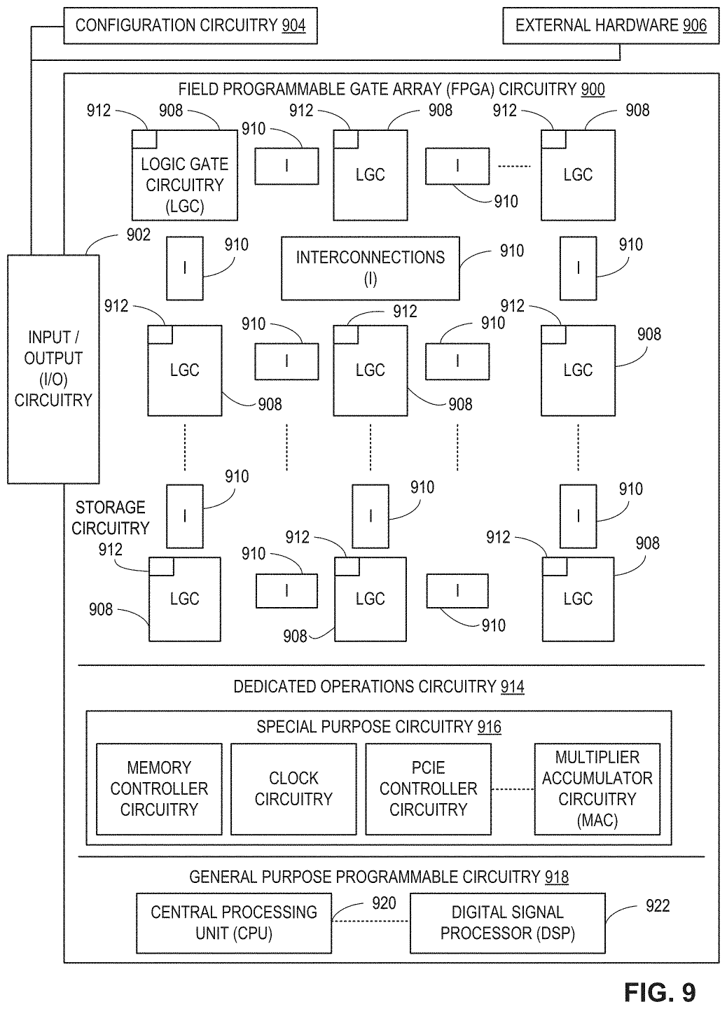

FIG. 9 is a block diagram of another example implementation of the processor circuitry 712 of FIG. 7. In this example, the processor circuitry 712 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor circuitry 800 of FIG. 8 described above (which is a general purpose device that may be programmed to execute some or all of the machine readable instructions represented by the flowcharts of FIGS. 5 and 6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 5 and 6. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 5 and 6. As such, the FPGA circuitry 900 may be structured to effectively instantiate some or all of the machine readable instructions of the flowchart of FIGS. 5 and 6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 5 and 6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may implement the microprocessor circuitry 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 5 and 6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 4 may additionally be implemented by combining the example microprocessor circuitry 800 of FIG. 8 and the example FPGA circuitry 900 of FIG. 9. In some such hybrid examples, a first portion of the machine readable instructions represented by the flowcharts of FIGS. 5 and 6 may be executed by one or more of the cores 802 of FIG. 8, a second portion of the machine readable instructions represented by the flowcharts of FIGS. 5 and 6 may be executed by the FPGA circuitry 900 of FIG. 9, and/or a third portion of the machine readable instructions represented by the flowcharts of FIGS. 5 and 6 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 912 of FIG. 9 may be in one or more packages. For example, the processor circuitry 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

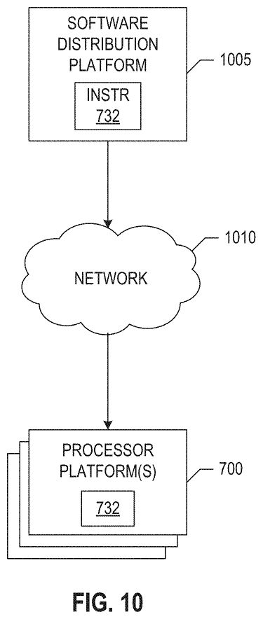

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions 732 of FIGS. 5 and 6, as described above. The one or more servers of the example software distribution platform 1005 are in communication with a network 1010, which may correspond to any one or more of the Internet and/or any of the example networks 120 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions 732 of FIG. 7, may be downloaded to the example processor platform 700, which is to execute the machine readable instructions 732 to implement the example model analysis system 102. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that enable development of accurate trained models that can facilitate program synthesis. As a result, examples disclosed herein can improve the results (e.g., programs) generated via program synthesis. Examples disclosed herein can also facilitate improved operation of GA program generation by providing a selection of candidate programs with relatively higher fitness. The disclosed systems, methods, apparatus, and articles of manufacture improve the efficiency of using a computing device by enabling quicker and potentially processor-efficient development of trained models with a relatively high degree of accuracy by enabling more efficient determination and/or evaluation of results from program synthesis implementations. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to train models for program synthesis are disclosed herein. Further examples and combinations thereof include the following:

Example 1 includes an apparatus comprising at least one memory, instructions, and processor circuitry to execute the instructions to sample pairs of programs, the pairs of programs including first programs and second programs, the first programs including natural language descriptions, calculate program similarity scores corresponding to the pairs of programs, and train a model based on entries corresponding to ones of the pairs of programs, at least one of the entries including a corresponding one of the natural language descriptions with a paired one of the second programs, and a corresponding one of the program similarity scores.

Example 2 includes the apparatus as defined in example 1, wherein the entries further include a corresponding one of the first programs paired with the one of the second programs.

Example 3 includes the apparatus as defined in example 1, wherein the processor circuitry is to execute the instructions to generate the second programs with a genetic algorithm.

Example 4 includes the apparatus as defined in example 1, wherein the processor circuitry is to execute the instructions to train the model further based on at least one of an input or an output associated with the input.

Example 5 includes the apparatus as defined in example 4, wherein the ones of the entries further include the input and the output, the output generated by providing the input to one of at least one of the first or second programs.

Example 6 includes the apparatus as defined in example 1, wherein the processor circuitry is to execute the instructions to filter the pairs of programs.

Example 7 includes the apparatus as defined in example 6, wherein the processor circuitry is to execute the instructions to filter the pairs of programs by removing ones of the pairs of programs that have predominant scores.

Example 8 includes the apparatus as defined in example 1, wherein the processor circuitry is to execute the instructions to calculate the program similarity scores via a code semantics similarity algorithm.

Example 9 includes the apparatus as defined in example 1, wherein the processor circuitry is to execute the instructions to train the model with a long-short-term memory (LSTM) neural network.

Example 10 includes the apparatus as defined in example 9, wherein the LSTM neural network is a bi-directional LSTM training network.

Example 11 includes a non-transitory computer readable medium comprising instructions, which when executed, cause at least one processor to sample pairs of programs, the pairs of programs including first programs and second programs, the first programs including natural language descriptions, calculate program similarity scores corresponding to the pairs of programs, and train a model based on entries corresponding to ones of the pairs of programs, at least one of the entries including a corresponding one of the natural language descriptions with a paired one of the second programs, and a corresponding one of the program similarity scores.

Example 12 includes the computer readable medium as defined in example 11, wherein ones of the entries further include a corresponding one of the first programs paired with the one of the second programs.

Example 13 includes the computer readable medium as defined in example 11, wherein the instructions cause the at least one processor to generate the second programs with a genetic algorithm.

Example 14 includes the computer readable medium as defined in example 11, wherein the instructions cause the at least one processor to train the model further based on at least one of an input or an output associated with the input.

Example 15 includes the computer readable medium as defined in example 14, wherein the ones of the entries further include the input and the output, the output generated by providing the input to one of at least one of the first or second programs.

Example 16 includes the computer readable medium as defined in example 11, wherein the instructions cause the at least one processor to filter the pairs of programs.

Example 17 includes the computer readable medium as defined in example 16, wherein the pairs of programs are filtered by removing ones of the pairs of programs that have predominant scores.

Example 18 includes the computer readable medium as defined in example 11, wherein the instructions cause the at least one processor to calculate the program similarity scores via a code semantics similarity algorithm.

Example 19 includes the computer readable medium as defined in example 11, wherein the instructions cause the at least one processor to train the model with a long-short-term memory (LSTM) neural network.

Example 20 includes the computer readable medium as defined in example 19, wherein the LSTM neural network is a bi-directional LSTM neural network.

Example 21 includes a method comprising sampling, by executing instructions with at least one processor, pairs of programs, the pairs of programs including first programs and second programs, the first programs including natural language descriptions, calculating, by executing instructions with the at least one processor, program similarity scores corresponding to the pairs of programs, and training, by executing instructions with the at least one processor, a model based on entries corresponding to ones of the pairs of programs, at least one of the entries including a corresponding one of the natural language descriptions with a paired one of the second programs, and a corresponding one of the program similarity scores.

Example 22 includes the method as defined in example 21, wherein ones of the entries further include a corresponding one of the first programs paired with the one of the second programs.

Example 23 includes the method as defined in example 21, further including generating, by executing instructions with the at least one processor, the second programs with a genetic algorithm.

Example 24 includes the method as defined in example 21, wherein the model is further trained based on at least one of an input or an output associated with the input.

Example 25 includes the method as defined in example 24, wherein the ones of the entries further include the input and the output, the output generated by providing the input to one of at least one of the first or second programs.

Example 26 includes the method as defined in example 21, further including filtering, by executing instructions with the at least one processor, the pairs of programs.

Example 27 includes the method as defined in example 26, wherein the pairs of programs are filtered by removing ones of the pairs of programs that have predominant scores.

Example 28 includes the method as defined in example 21, further including calculating, by executing instructions with the at least one processor, the program similarity scores via a code semantics similarity algorithm.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
at least one memory;
instructions; and
processor circuitry to execute the instructions to:
sample pairs of programs, the pairs of programs including first programs and second programs, the first programs including natural language descriptions,
calculate program similarity scores corresponding to the pairs of programs, and
train a model based on entries corresponding to ones of the pairs of programs, at least one of the entries including:
a corresponding one of the natural language descriptions with a paired one of the second programs, and
a corresponding one of the program similarity scores.

2. The apparatus as defined in claim 1, wherein the entries further include a corresponding one of the first programs paired with the one of the second programs.

3. The apparatus as defined in claim 1, wherein the processor circuitry is to execute the instructions to generate the second programs with a genetic algorithm.

4. The apparatus as defined in claim 1, wherein the processor circuitry is to execute the instructions to train the model further based on at least one of an input or an output associated with the input.

5. The apparatus as defined in claim 4, wherein the ones of the entries further include the input and the output, the output generated by providing the input to one of at least one of the first or second programs.

6. The apparatus as defined in claim 1, wherein the processor circuitry is to execute the instructions to filter the pairs of programs.

7. The apparatus as defined in claim 6, wherein the processor circuitry is to execute the instructions to filter the pairs of programs by removing ones of the pairs of programs that have predominant scores.

8. The apparatus as defined in claim 1, wherein the processor circuitry is to execute the instructions to calculate the program similarity scores via a code semantics similarity algorithm.

9. The apparatus as defined in claim 1, wherein the processor circuitry is to execute the instructions to train the model with a long-short-term memory (LSTM) neural network.

10. The apparatus as defined in claim 9, wherein the LSTM neural network is a bi-directional LSTM training network.

11. A non-transitory computer readable medium comprising instructions, which when executed, cause at least one processor to:
sample pairs of programs, the pairs of programs including first programs and second programs, the first programs including natural language descriptions;
calculate program similarity scores corresponding to the pairs of programs; and
train a model based on entries corresponding to ones of the pairs of programs, at least one of the entries including:
a corresponding one of the natural language descriptions with a paired one of the second programs, and
a corresponding one of the program similarity scores.

12. The computer readable medium as defined in claim 11, wherein ones of the entries further include a corresponding one of the first programs paired with the one of the second programs.

13. The computer readable medium as defined in claim 11, wherein the instructions cause the at least one processor to generate the second programs with a genetic algorithm.

14. The computer readable medium as defined in claim 11, wherein the instructions cause the at least one processor to train the model further based on at least one of an input or an output associated with the input.

15. The computer readable medium as defined in claim 14, wherein the ones of the entries further include the input and the output, the output generated by providing the input to one of at least one of the first or second programs.

16. The computer readable medium as defined in claim 11, wherein the instructions cause the at least one processor to filter the pairs of programs.

17. The computer readable medium as defined in claim 16, wherein the pairs of programs are filtered by removing ones of the pairs of programs that have predominant scores.

18. The computer readable medium as defined in claim 11, wherein the instructions cause the at least one processor to calculate the program similarity scores via a code semantics similarity algorithm.

19. The computer readable medium as defined in claim 11, wherein the instructions cause the at least one processor to train the model with a long-short-term memory (LSTM) neural network.

20. The computer readable medium as defined in claim 19, wherein the LSTM neural network is a bi-directional LSTM neural network.

21. A method comprising:
sampling, by executing instructions with at least one processor, pairs of programs, the pairs of programs including first programs and second programs, the first programs including natural language descriptions;
calculating, by executing instructions with the at least one processor, program similarity scores corresponding to the pairs of programs; and
training, by executing instructions with the at least one processor, a model based on entries corresponding to ones of the pairs of programs, at least one of the entries including:
a corresponding one of the natural language descriptions with a paired one of the second programs, and
a corresponding one of the program similarity scores.

22. The method as defined in claim 21, wherein ones of the entries further include a corresponding one of the first programs paired with the one of the second programs.

23. The method as defined in claim 21, further including generating, by executing instructions with the at least one processor, the second programs with a genetic algorithm.

24. The method as defined in claim 21, wherein the model is further trained based on at least one of an input or an output associated with the input.

25. The method as defined in claim 24, wherein the ones of the entries further include the input and the output, the output generated by providing the input to one of at least one of the first or second programs.

26. The method as defined in claim 21, further including filtering, by executing instructions with the at least one processor, the pairs of programs.

27. The method as defined in claim 26, wherein the pairs of programs are filtered by removing ones of the pairs of programs that have predominant scores.

28. The method as defined in claim 21, further including calculating, by executing instructions with the at least one processor, the program similarity scores via a code semantics similarity algorithm.
